(19) United States
(12) Patent Application Publication
(10) Pub. No.: US 2026/0284640 A1
(43) Pub. Date: Sep. 24, 2026

(54) TRI-METALLIC CATALYST FOR AMMONIA CRACKING, PREPARATION METHOD THEREFOR, AND PRODUCTION METHOD FOR HYDROGEN USING SAME

(71) Applicant: HEESUNG CATALYSTS CORPORATION, Gyeonggi-do (KR)

(72) Inventors: Ho Dong Kim, Incheon (KR); Min Sik Kim, Gyeonggi-do (KR); Hyun-sik Han, Seoul (KR); Dong Kun Kang, Gyeonggi-do (KR); Hyung Won Ham, Seoul (KR); Ki Jung Kim, Seoul (KR)

(21) Appl. No.: 19/474,586

(22) PCT Filed: Apr. 1, 2024
(86) PCT No.: PCT/KR2024/004144

§ 371 Date: Oct. 10, 2025

(30) Foreign Application Priority Data
Apr. 17, 2023 (KR) 10-2023-0049873

(51) Int. Cl. B01J 23/58; B01J 21/04; B01J 35/61; B01J 35/63; B01J 35/64; B01J 37/04; B01J 37/08; C01B 3/047

(52) U.S. Cl. CPC B01J 23/58; B01J 21/04; B01J 35/615; B01J 35/633; B01J 35/647; B01J 37/04; B01J 37/08; C01B 3/047; C01B 2203/0277

(57) ABSTRACT

Described is a preparation method for a complex metal catalyst in the form of a triple metal of ruthenium, yttrium, and potassium by using a thermally transformed delta-alumina support and to a production method for hydrogen through ammonia cracking using same. The described catalyst for ammonia cracking attains the adjustment of the ratio of ruthenium/[potassium+yttrium], along with a thermally transformed alumina support in a specific phase, even when using a low content of a ruthenium metal, the minimization of the contents of chlorine and nitrogen compounds, which are impurities in the catalyst, and the localization of active metals in the catalyst, thus achieving a very high ammonia conversion rate and hydrogen production efficiency even at a low temperature, compared with a catalyst having the same ruthenium metal content.

### TECHNICAL FIELD

The present disclosure relates to a high-yield tri-metallic catalyst composition being a catalyst for ammonia cracking to produce hydrogen and being capable of stably producing hydrogen at a low temperature, a preparation method thereof, and a production method of hydrogen using the same.

### BACKGROUND ART

Recently, there has been a growing demand for energy worldwide due to industrial development and population growth. However, fossil raw materials used as energy sources are being gradually depleted. Furthermore, to counteract global warming caused by greenhouse gases, ongoing research on clean energy sources that can replace fossil raw materials continues in each country. Of all energy sources, hydrogen is the most actively researched material as an environmentally friendly energy source.

There has been extensive research conducted on the ammonia cracking process, environmentally friendly hydrogen production technology, for producing hydrogen from ammonia. Ammonia cracking, an endothermic reaction in which ammonia is decomposed into hydrogen and nitrogen, requires a supply of heat. Because ammonia cracking allows complete conversion of ammonia to hydrogen at an ammonia decomposition temperature in the range of about 450° C. to 500° C., which is relatively low, based on equilibrium conversion, the energy cost is relatively low. However, ammonia cracking is an endothermic reaction in practice and thus requires high temperatures (500° C. or higher). Accordingly, further development is needed to enable this reaction to proceed in a mild temperature range. One approach among those is to develop a catalyst capable of achieving a high ammonia conversion rate at low temperatures.

It has been reported that catalyst compositions developed to date include precious metals, such as platinum, palladium, rhodium, ruthenium, and iridium, or non-precious metals, such as nickel, copper, chromium, cobalt, and iron, as active metals. In the case of supports, research on silica, alumina, activated carbon, graphite, mesoporous carbon, carbon nanotubes, and the like has been reported (Muhammad Aziz et al., Energies 2020, 13, 3062). Extensive research has been conducted to date on catalysts composed of combinations of the aforementioned active metals and supports. However, most catalysts allow ammonia to be converted to hydrogen at a conversion rate of 100% only at operating temperatures of 600° C. or higher, so highly active catalysts at lower temperatures are required for practical application to industrial crackers. Especially in the fields of ships and small-scale ammonia co-firing power generation, catalysts that enable operation at reaction temperatures in the range of about 300° C. to 500° C. are required.

As described above, most of the catalysts for ammonia cracking known in the art require high reaction temperatures to improve the ammonia conversion rate and contain a large amount of expensive metals supported on these catalysts, resulting in significantly reduced economic feasibility, which is problematic. Therefore, improvements in this regard are required. Additionally, the present disclosure aims to solve this problem by preparing a catalyst using a method in which a low content of ruthenium and auxiliary metals are combined, along with a particular catalyst support.

### DISCLOSURE

### Technical Problem

The present disclosure, which has been devised to address the aforementioned problems, primarily aims to provide a preparation method of a catalyst for ammonia cracking, the catalyst being capable of improving the ammonia conversion rate at a low temperature and exhibiting long-term stability by preparing a catalyst using a low content of ruthenium, a particular support, and potassium and yttrium serving as auxiliary metals, and a production method of hydrogen through ammonia cracking using the same.

### Technical Solution

To achieve the aforementioned technical purposes, the inventors of the present disclosure have prepared a catalyst by using an alumina support having a specific crystal phase so that ammonia, serving as a reactant, can diffuse within the catalyst and a product can be rapidly transferred outside the catalyst, and by locating ruthenium, serving as a main metal, and yttrium and potassium, serving as auxiliary metals capable of increasing the reaction rate of ruthenium, in a tri-metallic form on the prepared support so that the unique properties of each metal can be exhibited.

In the catalyst prepared according to the present disclosure, yttrium (Y) is combined with the alumina support and thus exists in the form of Al—Y—O—Al—O, and not only functions to decompose, dissociate, and adsorb the hydrogen ions of ammonia, but also enhances the mobility of the hydrogen ions toward Ru to accelerate the production rate of H₂. Additionally, potassium (K) has been confirmed to weaken the adsorption strength of the resulting N₂ after cracking onto the catalyst, induce rapid desorption from the catalyst to accelerate the rate of catalysis, and enhance durability. Furthermore, by separately configuring a process of removing residual chlorine and nitrogen compounds from the catalyst in the preparation process of the catalyst, it has been found that the number of active sites of ruthenium is maximized during ammonia cracking, thus exhibiting a high conversion rate at a low temperature.

The configuration of the present disclosure is, without limitation, as follows.
(1) A catalyst for ammonia cracking being a catalyst used to produce nitrogen and hydrogen through ammonia cracking, the catalyst being characterized in that thermally transformed delta-alumina from hydrated alumina serves as a catalyst support, a complex metal in a tri-metallic form composed of ruthenium, yttrium, and potassium is supported as an active metal, and chlorine and nitrogen compounds are present in the catalyst in an amount of 10 ppm or less with respect to the weight of the catalyst.
(2) The catalyst for ammonia cracking, characterized in that the prepared alumina and hydrated alumina, shaped into the form of a sphere, a tablet, or a structure, are thermally transformed and used as the support, and the delta-alumina serving as the support, the phase of which is transformed after the thermal treatment, has a bulk density in a range of 0.5 to 1.2 g/ml, a specific surface area in a range of 100 to 200 m²/g, a pore volume in a range of 0.4 to 0.5 cm³/g, and an average pore size distribution in a range of 10 to 14 nm.
(3) The catalyst for ammonia cracking, characterized in that ruthenium, serving as a main metal in the catalyst, is distributed within 30% of a distance from a periphery of the catalyst toward the center of the catalyst, and yttrium and potassium, serving as auxiliary metals, are distributed uniformly within the catalyst.
(4) The catalyst for ammonia cracking, characterized in that the ruthenium accounts for 0.5 to 3.0 wt % with respect to the weight of the catalyst and is present in an amount in a range of 0.005 to 0.028 wt % per m² of specific surface area within 30% of a distance from a periphery of the catalyst toward the center of the catalyst, and the yttrium and potassium are present uniformly within the catalyst in an amount in a range of 0.01 to 0.05 wt % per m² of specific surface area.
(5) The catalyst for ammonia cracking, characterized in that in the active metal, a weight ratio of (yttrium+potassium)/ruthenium is in a range of 4 to 8, a weight ratio of yttrium/ruthenium is in a range of 1 to 2, and a weight ratio of potassium/ruthenium is in a range of 3 to 6.
(6) The catalyst for ammonia cracking, characterized in that the residual chlorine and nitrogen compounds are removed from the catalyst to an amount of 10 ppm or less with respect to the weight of the catalyst through ion exchange using a basic substance and high-temperature thermal treatment, respectively.
(7) A preparation method of a catalyst for use in ammonia cracking, the method being characterized by including the following steps: a) preparing an alumina support having a delta-crystal phase by thermally treating spherical boehmite (AlOOH) at a temperature in a range of 750° C. to 900° C.; b) supporting a solution in which a yttrium precursor (Y(NO₃)₃) is mixed and dissolved in a solvent, on the resulting delta-alumina (δ-Al₂O₃) support by pressurized spray at room temperature, thereby obtaining yttrium/delta-alumina; c) drying the yttrium/delta-alumina at a temperature in a range of 100° C. to 120° C. after the supporting, followed by firing at a temperature in a range of 500° C. to 600° C.; d) supporting a solution in which a ruthenium precursor (RuCl₃) is dissolved in a solvent, on the resulting yttrium/delta-alumina material by pressurized spray at room temperature, thereby obtaining a ruthenium/yttrium/delta-alumina material; e) drying the ruthenium/yttrium/delta-alumina material at a temperature in a range of 100° C. to 120° C. after the supporting, followed by firing at a temperature in a range of 500° C. to 600° C., and removing residual Cl through ion exchange; f) supporting a solution in which a potassium precursor (KNO₃) is dissolved in a solvent, on the resulting ruthenium/yttrium/delta-alumina material by pressurized spray at room temperature, thereby obtaining a potassium/ruthenium/yttrium/delta-alumina material; g) drying the potassium/ruthenium/yttrium/delta-alumina material at a temperature in a range of 100° C. to 120° C. after the supporting, followed by removing residual NO₃ through firing at a temperature in a range of 500° C. to 600° C., thereby obtaining a potassium/ruthenium/yttrium/delta-alumina oxide catalyst; and h) subjecting the resulting potassium/ruthenium/yttrium/delta-alumina oxide catalyst to a rapid reduction process at a high temperature in a range of 400° C. to 500° C. using hydrogen gas, thereby preparing a final catalyst.
(8) The catalyst for ammonia cracking, characterized by being used in ammonia cracking to allow ammonia gas to react at a reaction temperature in a range of 300° C. to 550° C. under a condition of a gas hourly space velocity in a range of 2,000 to 20,000 h⁻¹, thereby exhibiting a high conversion rate to hydrogen.

### Advantageous Effects

The present disclosure relates to a ruthenium-based catalyst for ammonia cracking and, in particular, relates to a catalyst for ammonia cracking prepared by selecting ruthenium, serving as a main metal, and yttrium and potassium, serving as auxiliary metals, as active metals, in addition to a delta-alumina support, and a preparation method thereof. The catalyst for ammonia cracking, according to the present disclosure, attains the adjustment of the weight ratio of ruthenium/yttrium/potassium, along with the thermally transformed alumina support in a specific phase, even when using a low content of ruthenium metal, the minimization of the contents of chlorine and nitrogen compounds, which are impurities in the catalyst, and the localization of the active metals in the catalyst, thus achieving a significantly high ammonia conversion rate and hydrogen production efficiency even at a low temperature, compared with a catalyst having the same ruthenium metal content.

### DESCRIPTION OF DRAWINGS

FIG. 1 illustrates the steps of a preparation method in Example 1 of the present disclosure as a flowchart.

FIG. 2 shows images of a catalyst prepared in Example 1 of the present disclosure, the images taken using an electron microscope (video microscopy) and an electron probe X-ray microanalyzer (EPMA).

### BEST MODE

### Definition

In the present disclosure, an active metal is a term encompassing a main metal and auxiliary metals, and a support, an oxide for supporting the active metal, is also referred to as a carrier.

The present disclosure relates to a catalyst for ammonia cracking to produce hydrogen and a preparation method thereof and, in particular, relates to a catalyst prepared through a process in which a delta-alumina support with controlled acid sites and pore size is prepared, ruthenium, serving as a main metal, and yttrium and potassium, serving as auxiliary metals, are selected as active metals, and residual chlorine and nitrogen compounds derived from metal precursors are removed from the catalyst, and to a preparation method thereof.

According to the present disclosure, hydrogen could be produced at a rapid rate by ruthenium from hydrogen ions dissociated through the combination of yttrium and the support. When such a reaction continues, the particle size of ruthenium gradually becomes larger due to sintering, resulting in a lower conversion rate during cracking. To prevent such sintering, it has been found that potassium is strongly combined with ruthenium to suppress the growth of ruthenium particles during the reaction and can function to enhance the durability of the catalyst.

Additionally, when the main metal of the active metal is distributed typically throughout the support, the contact frequency between the reactant and the support/active metal is reduced, resulting in a loss in the amount of hydrogen produced per unit time (ammonia conversion rate). To address this problem, by locating ruthenium on the surface of the support, ruthenium concentrated on the surface of the catalyst was designed to increase the amount of hydrogen produced even when the reactant entered a reactor at a high space velocity. Yttrium and potassium were distributed uniformly within the support to maximize interaction with the alumina support, thereby preparing the catalyst.

Hereinafter, a preferred embodiment of the present disclosure is to be described in detail.

A complex metal catalyst having a form in which ruthenium and auxiliary metals are supported on a thermally transformed alumina support with controlled crystal phase and pore characteristics, according to the present disclosure, may be prepared through the following steps:
a) preparing an alumina support having a delta-crystal phase by thermally treating spherical boehmite (AlOOH) at a temperature in the range of 750° C. to 900° C.;
b) supporting a solution in which a yttrium precursor (Y(NO₃)₃) is mixed and dissolved in a solvent, on the resulting delta-alumina (δ-Al₂O₃) support by pressurized spray at room temperature, thereby obtaining yttrium/delta-alumina;
c) drying the yttrium/delta-alumina at a temperature in the range of 100° C. to 120° C. after supporting yttrium, followed by firing at a temperature in the range of 500° C. to 600° C.;
d) supporting a solution in which a ruthenium precursor (RuCl₃) is dissolved in a solvent, on the resulting yttrium/delta-alumina material by pressurized spray at room temperature, thereby obtaining a ruthenium/yttrium/delta-alumina material;
e) drying the ruthenium/yttrium/delta-alumina material at a temperature in the range of 100° C. to 120° C. after supporting ruthenium, followed by firing at a temperature in the range of 500° C. to 600° C., and removing residual Cl through ion exchange;
f) supporting a solution in which a potassium precursor (KNO₃) is dissolved in a solvent, on the resulting ruthenium/yttrium/delta-alumina material by pressurized spray at room temperature, thereby obtaining a potassium/ruthenium/yttrium/delta-alumina material;
g) drying the potassium/ruthenium/yttrium/delta-alumina material at a temperature in the range of 100° C. to 120° C. after supporting potassium, followed by removing residual NO₃ through firing at a temperature in the range of 500° C. to 600° C., thereby obtaining a potassium/ruthenium/yttrium/delta-alumina oxide catalyst; and
h) subjecting the resulting potassium/ruthenium/yttrium/delta-alumina oxide catalyst to a rapid reduction process at a high temperature in the range of 400° C. to 500° C. using hydrogen gas, thereby preparing a final catalyst.

Each step is to be described in detail.

In Step a), the alumina support may be prepared using boehmite or gamma-alumina as the starting material, which may be thermally treated in a thermal treatment furnace at a temperature in the range of 750° C. to 900° C. for 1 to 5 hours in order to remove acid sites of the support and control pore size and transformed into a crystal phase having 90% or more delta-alumina. While the thermal treatment temperature is closely related to the crystal phase and pore structure of the support, there are four alumina phases (gamma, delta, theta, and alpha) of boehmite present depending on the thermal treatment temperature, among which delta-alumina is formed by the occurrence of a phase transition at a temperature in the range of about 750° C. to 900° C. Table 1 shows the crystal phase and changes in specific surface area, pore volume, and pore size of alumina observed when thermally treating boehmite at each temperature.

TABLE 1
(Pore Characteristics at Each Firing Temperature of Support)

| | | Alumina phase | Specific | | |
|---|---|---|---|---|---|
| | Treatment | after thermal | surface | Pore | Pore |
| Starting | temperature | treatment | area | volume | size |
| material | (° C.) | (crystal phase) | (m²/g) | (cm³/g) | (nm) |
| Boehmite | 450 | Gamma-alumina (γ- | 206 | 0.49 | 9.5 |
| (AlOOH) | | Al₂O₃) | | | |
| | 850 | Delta-alumina (δ- | 158 | 0.47 | 12.1 |
| | | Al₂O₃) | | | |
| | 900 | Delta-alumina (δ- | 153 | 0.47 | 12.6 |
| | | Al₂O₃) | | | |
| | 1000 | Theta-alumina (θ- | 93 | 0.33 | 14.1 |
| | | Al₂O₃) | | | |
| | 1200 | Alpha-alumina (α- | 3 | 0.04 | 98 |
| | | Al₂O₃) | | | |

Delta-alumina is characterized by providing more space within the alumina for the active metals to be located due to an increased pore size while having a specific surface area similar to that of gamma-alumina, and weakening the Lewis and Brønsted acid sites present in gamma-alumina, thus allowing ammonia, serving as the reactant, to react only on the active metals. A high specific surface area improves the dispersibility of metals when supporting the active metals, and an increased pore size can increase the reaction rate of the catalyst by improving air permeability between the reactant and the catalyst when applied to cracking, which is advantageous.

On the other hand, the pore size of theta- or alpha-alumina thermally treated at a further higher temperature, especially 900° C. or higher, is further increased, but the specific surface area thereof is rapidly reduced. Accordingly, in the process of supporting the active metals, aggregation of the metal particles occurs, resulting in a low degree of dispersion, which is disadvantageous. For this reason, theta- or alpha-alumina is unsuitable as the support to be used in the preparation method of the present disclosure. The resulting alumina support may have a bulk density in the range of 0.5 to 1.2 g/ml, a specific surface area in the range of 100 to 200 m²/g, a pore volume in the range of 0.4 to 0.5 cm³/g, an average pore size distribution in the range of 10 to 14 nm, and a ratio of delta-alumina/gamma-alumina of 9 or more. The support used may be shaped into the form of a sphere, a cylinder, a pellet, or a tube, and such shapes may be prepared by methods such as oil-dropping, tableting, and extrusion.

In Step b), as for the yttrium precursor, one of hydrated yttrium nitrate, hydrated yttrium chloride, hydrated yttrium acetate, and hydrated yttrium sulfate may be used. Preferably, yttrium nitrate capable of improving the degree of dispersion of ruthenium may be used to prepare the yttrium/delta-alumina. The yttrium/delta-alumina may be prepared by a method in which the yttrium precursor is dissolved in ionized water or dihydric alcohol (such as ethanol or ethylene glycol), serving as the solvent, in an amount corresponding to the pore volume of the support, thereby supporting the resulting solution on the support using pressurized spray. In the meantime, 1 to 4 wt % of the yttrium precursor may be supported, with respect to the weight of the final catalyst. When 1 wt % or less of the yttrium precursor is supported, the performance of the catalyst may be unlikely to be realized, and when 4 wt % or more of the yttrium precursor is supported, the yttrium precursor may fail to enter the support and partially accumulate on the surface of the support, resulting in low activity of ruthenium and thus leading to deterioration in durability. The yttrium precursor may be supported such that the weight ratio of yttrium/ruthenium falls within the range of about 1 to 2 and, preferably, is prepared such that the weight ratio of yttrium/ruthenium is about 1.

To remove moisture and precursor materials, derived from the metal precursor, from the yttrium/delta-alumina prepared in Step b), Step c) may involve a step of drying the yttrium/delta-alumina at a temperature in the range of 100° C. to 120° C., followed by thermal treatment at a temperature in the range of 500° C. to 600° C. for the preparation.

In Step d), as for the ruthenium precursor, one of hydrated ruthenium nitrate, hydrated ruthenium chloride, hydrated ruthenium acetate, hydrated ruthenium hydroxide, and hydrated ruthenium nitrosyl nitrate may be used. Preferably, ruthenium chloride capable of improving the dispersibility of ruthenium may be used to prepare the ruthenium/yttrium/delta-alumina material. The ruthenium/yttrium/delta-alumina material may be prepared by a method in which the active metal precursor is dissolved in ionized water or dihydric alcohol (such as ethanol or ethylene glycol), serving as the solvent, in an amount corresponding to the pore volume of the support, thereby supporting the resulting solution on the support using pressurized spray. The ruthenium precursor may be supported such that the weight ratio thereof with respect to the final catalyst falls within the range of about 0.5 to 3 and, preferably, is prepared such that the weight ratio falls within the range of about 1 to 2 for commercial application.

To remove moisture and precursor materials, derived from the metal precursor, from the ruthenium/yttrium/delta-alumina material prepared in Step d), Step e) may involve a step of drying the ruthenium/yttrium/delta-alumina material at a temperature in the range of 100° C. to 120° C., followed by thermal treatment at a temperature in the range of 500° C. to 600° C. in an air atmosphere for the preparation. Additionally, when ruthenium chloride, among the metal precursor materials, is used, chloride ions may remain even after the thermal treatment, so a process of removing such residues through ion exchange using a basic substance may be added. As for the basic substance, one of ammonium hydroxide, ammonium nitrate, sodium hydroxide, and sodium nitrate may be used. Preferably, ammonium hydroxide, which is easy to clean, may be used.

In Step f), as for the potassium precursor, one of hydrated potassium nitrate, hydrated potassium chloride, hydrated potassium acetate, and hydrated potassium hydroxide may be used. Preferably, potassium nitrate capable of improving the dispersibility of ruthenium may be used to prepare the potassium/ruthenium/yttrium/delta-alumina material. The potassium/ruthenium/yttrium/delta-alumina material may be prepared by a method in which the potassium precursor is dissolved in ionized water or dihydric alcohol (such as ethanol or ethylene glycol), serving as the solvent, in an amount corresponding to the pore volume of the support, thereby supporting the resulting solution on the support using pressurized spray. In the meantime, 4 to 10 wt % of the potassium precursor may be supported, with respect to the weight of the final catalyst. When 4 wt % or less of the potassium precursor is supported, the performance of the catalyst may be unlikely to be realized, and when 10 wt % or more of the potassium precursor is supported, the potassium precursor may fail to enter the support and partially accumulate on the surface of the support, resulting in low activity of ruthenium and thus leading to deterioration in durability. The potassium precursor may be supported such that the weight ratio of potassium/ruthenium falls within the range of about 3 to 6 and, preferably, is prepared such that the weight ratio of potassium/ruthenium falls within the range of about 3 to 4.

To remove moisture and precursor materials, derived from the metal precursor, from the potassium/ruthenium/yttrium/delta-alumina material prepared in Step f), Step g) may involve a step of drying the potassium/ruthenium/yttrium/delta-alumina material at a temperature in the range of 100° C. to 120° C., followed by thermal treatment at a temperature in the range of 500° C. to 600° C. in an air atmosphere for the preparation. The thermal treatment may be performed at a temperature that falls within an appropriate range based on common knowledge, so no further detailed description is to be given.

In Step h), the rapid reduction process is performed at a temperature in the range of 400° C. to 600° C., preferably in the range of 400° C. to 500° C., using hydrogen gas to exhibit the activity of the catalyst in the resulting potassium/ruthenium/yttrium/delta-alumina oxide prepared in Step g), thereby obtaining the final catalyst. In the reduction process, when the reduction temperature is 400° C. or lower, metal oxide species may fail to be completely reduced, and when the reduction temperature is higher than 600° C., aggregation and sintering of the metal particles may occur, leading to a decrease in the number of active sites. In the reduction process, after raising the temperature to a target temperature in a nitrogen atmosphere in a stepwise manner, the catalyst was prepared while flowing hydrogen gas. When two or more active metal species are contained in the catalyst, direct exposure to hydrogen gas at a high temperature may allow the active metal species to instantaneously form an alloy, as in the above reduction method. However, when the reduction is performed by gradually raising the temperature from room temperature in a hydrogen atmosphere, each metal is reduced at a unique oxygen desorption temperature, making it challenging to form an alloy.

In the present disclosure, the prepared catalyst, after introduced into a reactor, may be used in ammonia gas cracking and may allow ammonia gas to undergo a gas phase reaction at a reaction temperature in the range of 300° C. to 550° C. under a condition of a gas hourly space velocity (GHSV) in the range of 2,000 to 20,000 h⁻¹ to produce hydrogen. The higher the GHSV, the more the amount of hydrogen produced proportionally increases. Accordingly, the optimal value thereof may be adjusted arbitrarily in response to the reactor volume and the amount of the catalyst, and thus is not limited to a specific value within the range. The reactor in which hydrogen is produced through reforming is not particularly limited, but a fixed-bed catalytic reactor having a form in which the reactor is filled with the catalyst may be used. Additionally, because cracking is an endothermic reaction, keeping the catalytic reactor adiabatic at all times is crucial. In the cracking process of the present disclosure, it is important to perform the reaction while maintaining the reaction conditions, including the reaction temperature, pressure, and GHSV, within appropriate ranges. When the reaction temperature is lower than 300° C., cracking is unlikely to be performed sufficiently, thus obtaining a significantly low amount of hydrogen, and when the reaction temperature is 550° C. or higher, energy costs increase during commercial applications, resulting in low efficiency.

Hereinafter, the technical configuration of the present disclosure is to be described in detail in the following drawings, examples, and comparative examples.

### Example 1

Spherical boehmite (manufacturer: BASF, Germany; specific surface area: 250 m²/g) having a size of 1.8 mm, serving as a support, was fired at 900° C. for 5 hours to allow phase transition and then used. The support, the phase of which is transitioned, has a delta-alumina crystal phase and has the following physical properties: a specific surface area of 153 m²/g, a pore volume of 0.47 cm³/g, and a pore size of 12.6 nm. To primarily support metals, yttrium nitrate (Y(NO₃)₃·6H₂O) was used as a yttrium precursor. The yttrium precursor was dissolved in water, and the resulting solution was impregnated onto the delta-alumina support, the phase of which was transitioned, using spray impregnation. After impregnation, the resulting product was subjected to an aging process for about 1 hour so that the metal solution was distributed sufficiently inside the support, and dried at 120° C. for 12 hours to completely remove moisture from the catalyst, followed by undergoing a thermal treatment process in an air atmosphere at 600° C. for 6 hours to immobilize the metal. Next, to support ruthenium, selected as the main metal among the active metals, ruthenium chloride (RuCl₃·xH₂O) was used as a ruthenium precursor. The ruthenium precursor was dissolved in water, and the resulting solution was impregnated onto the yttrium/delta-alumina using spray impregnation. The resulting ruthenium/yttrium/delta-alumina was dried at 120° C. for 12 hours to completely remove moisture from the catalyst, followed by undergoing a thermal treatment process in an air atmosphere at 600° C. for 6 hours to immobilize the metal. Subsequently, ammonium water was additionally used in the thermally treated ruthenium/yttrium/delta-alumina oxide for ion exchange of residual chloride components in the oxide with ammonium chloride, followed by washing/removing.

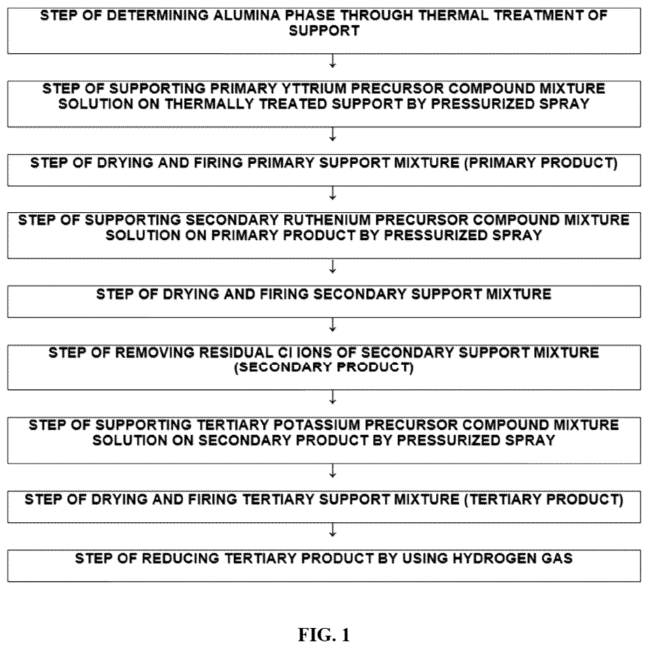

Thereafter, potassium nitrate (KNO₃) was also supported on the ruthenium/yttrium/delta-alumina oxide using spray impregnation. Ultimately, the resulting metal-supported potassium/ruthenium/yttrium/delta-alumina composition underwent a thermal treatment process in an air atmosphere at 550° C. for 4 hours, thereby preparing a metal-supported catalyst oxide. Lastly, after raising the temperature to 500° C. in an air atmosphere, the thermally treated oxide was purged with nitrogen for 5 minutes, followed by performing rapid reduction while flowing hydrogen gas to prepare a catalyst. The overall preparation sequence and method are shown in FIG. 1.

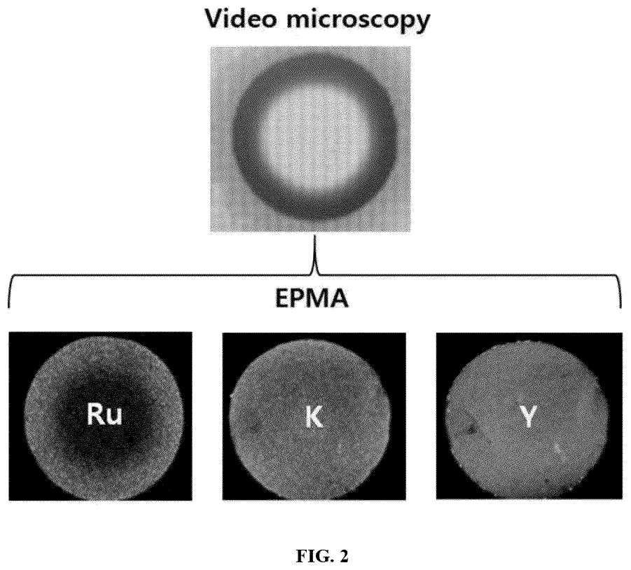

It was confirmed that the catalyst prepared in Example 1 contained 1.93 wt % of yttrium, 1.7 wt % of ruthenium, 6.8 wt % of potassium, 4 ppm of chloride ions, and 0 ppm of nitrate ions. Additionally, this catalyst was prepared such that yttrium and potassium were distributed uniformly within the support, and ruthenium was distributed within about 30% of the distance from the periphery of the catalyst. The distribution of the metals within the catalyst prepared in Example 1 is shown in FIG. 2.

### Example 2

In Example 2, a catalyst was prepared by performing the same method as in Example 1, except that the final catalyst was prepared to contain the metals in the following amounts: 3.86 wt % of yttrium, 1.7 wt % of ruthenium, and 6.8 wt % of potassium.

### Example 3

In Example 3, a catalyst was prepared by performing the same method as in Example 1, except that the final catalyst was prepared to contain the metals in the following amounts: 0.57 wt % of yttrium, 0.5 wt % of ruthenium, and 2.0 wt % of potassium.

### Comparative Example 1

In Comparative Example 1, a catalyst was prepared by performing the same method as in Example 1, except that the catalyst was prepared free of yttrium.

### Comparative Example 2

In Comparative Example 2, a catalyst was prepared by performing the same method as in Example 1, except that the catalyst was prepared free of potassium.

### Comparative Example 3

In Comparative Example 3, a catalyst was prepared by performing the same method as in Example 1, except that the catalyst was prepared free of yttrium and potassium.

### Comparative Example 4

In Comparative Example 4, a catalyst was prepared by performing the same method as in Comparative Example 3, except that the catalyst was prepared by supporting 2 wt % of ruthenium.

### Comparative Example 5

In Comparative Example 5, a catalyst was prepared by performing the same method as in Comparative Example 3, except that the catalyst was prepared by supporting 3 wt % of ruthenium.

### Comparative Example 6

In Comparative Example 6, a catalyst was prepared by performing the same method as in Example 1, except that the support used in Example 1 was subjected to thermal treatment at 1,000° C. when prepared. The crystal phase of the support in this catalyst was the theta phase. Additionally, the support had a specific surface area of 93 m²/g and a pore size of 14.1 nm.

### Comparative Example 7

In Comparative Example 7, a catalyst was prepared by performing the same method as in Example 1, except that the support used in Example 1 was subjected to thermal treatment at 1,200° C. when prepared. The crystal phase of the support in this catalyst was the alpha phase. Additionally, the support had a specific surface area of 3 m²/g and a pore size of 98 nm.

The material composition and active metal composition of the catalysts in the above examples and comparative examples are summarized and shown in Table 2.

TABLE 2
(Preparation Methods of Examples and Comparative Examples)

| | | Active metal composition in catalyst | | | |
|---|---|---|---|---|---|
| | | Ru | K | Y | (Y + K) /Ru |
| Classification | Support | (wt %) | (wt %) | (wt %) | (weight ratio) |
| Example 1 | δ-Al₂O₃ | 1.7 | 6.8 | 1.93 | 5.1 |
| Example 2 | δ-Al₂O₃ | 1.7 | 6.8 | 3.86 | 6.3 |
| Example 3 | δ-Al₂O₃ | 0.5 | 2.0 | 0.57 | 5.1 |
| Comparative | δ-Al₂O₃ | 1.7 | 6.8 | — | 4 |
| Example 1 | | | | | |
| Comparative | δ-Al₂O₃ | 1.7 | — | 1.93 | 1.1 |
| Example 2 | | | | | |
| Comparative | δ-Al₂O₃ | 1.7 | — | — | — |
| Example 3 | | | | | |
| Comparative | δ-Al₂O₃ | 2 | — | — | — |
| Example 4 | | | | | |
| Comparative | δ-Al₂O₃ | 3 | — | — | — |
| Example 5 | | | | | |
| Comparative | θ-Al₂O₃ | 1.7 | 6.8 | 1.93 | 5.1 |
| Example 6 | | | | | |
| Comparative | α-Al₂O₃ | 1.7 | 6.8 | 1.93 | 5.1 |
| Example 7 | | | | | |

### Reaction Example

The performance of the catalysts prepared in the above examples and comparative examples was evaluated as follows. Cracking was performed using ammonia gas to measure the activities of the catalysts, and a fixed-bed reaction system was used as a reactor for evaluation. The tubular reactor was filled with 3 ml of the catalyst. Then, the catalyst was reduced at 400° C. for 1 hour by flowing hydrogen gas constantly at 10 cc/min to remove oxygen species from the surface of the catalyst before performing the reaction. Subsequently, the temperature of the reactor was maintained at 300° C., 400° C., and 500° C. in a stepwise manner, followed by continuously supplying ammonia gas, serving as the raw material used in the reaction, to the reactor constantly at 100 cc/min, with the GHSV fixed constantly at 2,000 h⁻¹. The reaction pressure was evaluated under an atmospheric pressure condition. The resulting product after the reaction was transferred through an injection line to a gas chromatograph (GC) and quantitatively analyzed using a thermal conductivity detector (TCD).

When it comes to the reactant, the ammonia conversion rate was calculated by the following criteria to compare the activities of the catalysts. The results thereof are shown in Table 3.

$$Ammonia conversion rate ( \% ) = [ number of moles of ammonia before reaction - number of moles of ammonia after reaction ] / [ number of moles of ammonia before reaction ] \times 100$$

TABLE 3
(Evaluation Results of Ammonia Cracking
for Examples and Comparative Examples)

| | Ammonia conversion rate (%) | | |
|---|---|---|---|
| Classification | 300° C. | 400° C. | 500° C. |
| Example 1 | 9.0 | 45.0 | 100 |
| Example 2 | 6.0 | 37.0 | 100 |
| Example 3 | 0.7 | 21 | 68.0 |
| Comparative | 6.3 | 24.1 | 80.3 |
| Example 1 | | | |
| Comparative | 0.5 | 10.0 | 49.0 |
| Example 2 | | | |
| Comparative | 0.5 | 13.7 | 68.7 |
| Example 3 | | | |
| Comparative | 1.6 | 25.8 | 72.0 |
| Example 4 | | | |
| Comparative | 2.0 | 38.3 | 98.0 |
| Example 5 | | | |
| Comparative | 4.5 | 25.1 | 85.2 |
| Example 6 | | | |
| Comparative | 0.8 | 11.0 | 48.0 |
| Example 7 | | | |

All these catalysts were prepared such that ruthenium, serving as the main active metal, was located within about 30% of the distance from the periphery of the catalyst to increase the production rate of hydrogen from the reactant, and yttrium and potassium, serving as auxiliary metals, were distributed uniformly within the catalyst to maximize the interaction with the alumina support. Additionally, all chlorine and nitrogen compounds, impurities in the catalysts, were allowed to be removed. —Example 1 and Comparative Examples 1 to 3 describe the preparation of the catalysts with or without the addition of potassium and yttrium, serving as the auxiliary metals. As a result of evaluating the activities, Example 1 exhibited the highest low-temperature activity. Ultimately, the ammonia conversion rate was 100% at 500° C. In particular, the result showed that yttrium had an effect on improving the ammonia conversion rate at a low temperature, and potassium was a contributing factor capable of improving the overall conversion rate.
Comparative Examples 3 to 5 describe the preparation of the catalysts by changing the amount of ruthenium, serving as the main active metal, to 1.7 wt %, 2 wt %, and 3 wt %. Although the obtained result showed that the ammonia conversion rate was improved according to the amount of ruthenium supported, the conversion rate at 500° C. failed to reach 100%. However, the catalyst of Example 1, in which yttrium and potassium are supported in addition to 1.7 wt % of ruthenium, the content of which is the same as that in Comparative Example 3, exhibits a higher ammonia conversion rate than the catalyst of Comparative Example 5, in which 3 wt % of ruthenium is supported. Therefore, it is seen that the combination of ruthenium and the auxiliary metals can significantly contribute to improving the reaction activity.
Example 1 and Comparative Examples 6 and 7 describe the preparation of the catalysts by changing the crystal phase of alumina, serving as the catalyst support. As a result of evaluating the activities, Examples 6 and 7 exhibited lower ammonia cracking activity than Example 1. In particular, compared to Example 1, Comparative Example 7 exhibits a reactivity of about 11% at 400° C. and about 48% at 500° C. Therefore, it is seen that the crystal phase of the support has a significant effect on ammonia cracking.

Accordingly, as in Example 1, a catalyst using a support having a delta-alumina crystal phase and containing 1.7 wt % of ruthenium, 6.8 wt % of potassium, and 1.93 wt % of yttrium as metal components, with the weight ratio of [yttrium+potassium]/ruthenium being about 5.1, can be prepared, thereby preparing a catalyst exhibiting a high ammonia cracking conversion rate at a relatively low temperature in the range of 300° C. to 500° C.

1. A catalyst for ammonia cracking,
wherein thermally transformed delta-alumina from hydrated alumina serves as a catalyst support,
a complex metal in a tri-metallic form comprising ruthenium, yttrium, and
potassium is supported as an active metal, and
chlorine and nitrogen compounds are present in the catalyst in an amount of 10 ppm or less with respect to the weight of the catalyst.

2. The catalyst of claim 1, wherein the thermally transformed delta-alumina serving as the support has a bulk density in a range of 0.5 to 1.2 g/ml, a specific surface area in a range of 100 to 200 m²/g, a pore volume in a range of 0.4 to 0.5 cm³/g, and an average pore size distribution in a range of 10 to 14 nm.

3. The catalyst of claim 1, wherein the ruthenium is distributed within 30% of a distance from a periphery of the catalyst toward the center of the catalyst, and
the yttrium and potassium are distributed uniformly within the catalyst.

4. The catalyst of claim 1, wherein the ruthenium accounts for 0.5 to 3.0 wt % with respect to the weight of the catalyst and is present in an amount in a range of 0.005 to 0.028 wt %/m² within 30% of a distance from a periphery of the catalyst toward the center of the catalyst.

5. The catalyst of claim 1, wherein the yttrium and potassium are present uniformly within the catalyst in an amount in a range of 0.01 to 0.05 wt^{%/}m².

6. The catalyst of claim 1, wherein a weight ratio of (yttrium+potassium)/ruthenium is in a range of 4 to 8,
a weight ratio of yttrium/ruthenium is in a range of 1 to 2, and
a weight ratio of potassium/ruthenium is in a range of 3 to 6.

7. A preparation method of a catalyst for use in ammonia cracking, the method comprising:
a) preparing an alumina support having a delta-crystal phase by thermally treating spherical boehmite (AlOOH) at a temperature in a range of 750° C. to 900° C.;
b) supporting a solution in which a yttrium precursor (Y(NO₃)₃) is mixed and dissolved in a solvent, on the resulting delta-alumina (δ-Al₂O₃) support by pressurized spray at room temperature, thereby obtaining yttrium/delta-alumina;
c) drying the yttrium/delta-alumina at a temperature in a range of 100° C. to 120° C. after the supporting, followed by firing at a temperature in a range of 500° C. to 600° C.;
d) supporting a solution in which a ruthenium precursor (RuCl₃) is dissolved in a solvent, on the resulting yttrium/delta-alumina material by pressurized spray at room temperature, thereby obtaining a ruthenium/yttrium/delta-alumina material;
e) drying the ruthenium/yttrium/delta-alumina material at a temperature in a range of 100° C. to 120° C. after the supporting, followed by firing at a temperature in a range of 500° C. to 600° C., and removing residual Cl through ion exchange;
f) supporting a solution in which a potassium precursor (KNO₃) is dissolved in a solvent, on the resulting ruthenium/yttrium/delta-alumina material by pressurized spray at room temperature, thereby obtaining a potassium/ruthenium/yttrium/delta-alumina material;
g) drying the potassium/ruthenium/yttrium/delta-alumina material at a temperature in a range of 100° C. to 120° C. after the supporting, followed by removing residual NO₃ through firing at a temperature in a range of 500° C. to 600° C., thereby obtaining a potassium/ruthenium/yttrium/delta-alumina oxide catalyst; and
h) subjecting the resulting potassium/ruthenium/yttrium/delta-alumina oxide catalyst to a rapid reduction process at a high temperature in a range of 400° C. to 500° C. using hydrogen gas, thereby preparing a final catalyst.
